(19) United States
(12) Patent Application Publication
(10) Pub. No.: US 2021/0063532 A1
(43) Pub. Date: Mar. 4, 2021

(54) APPARATUS AND METHOD FOR RADAR CALIBRATION

(71) Applicant: QUALCOMM Incorporated, San Diego, CA (US)

(72) Inventor: Volodimir SLOBODYANYUK, San Diego, CA (US)

(21) Appl. No.: 16/553,000

(22) Filed: Aug. 27, 2019

(51) Int. Cl. G01S 7/40; G01S 13/93

(52) U.S. Cl. CPC G01S 7/40; G01S 13/931

(57) ABSTRACT

Various aspects may include an apparatus for radar calibration including a radar control system and a first radar antenna and a second radar antenna, one on the inside of a device housing area and the other on the outside of a device housing area. Both antennae may be mounted to the device housing area. By transmitting a signal from one antenna to the other, various aspects of the signal may be measured by the radar control system in order to determine a calibration parameter for radar calibration.

### BACKGROUND

### Field

The present disclosure relates to radar calibration devices, systems and methods.

### Background

Radar sensors can be used by electronic devices, such as mobile phones or automobiles, to sense targets at distances using radio frequency (RF) signals. These sensors can include and operate two separate parallel components: one for the receive side (Rx) and the other for the transmit side (Tx). Some radar sensors may need to operate in full-duplex mode, in which the both Tx and Rx sides operate simultaneously, to sense nearby targets. Radar sensors must be calibrated to account for the physical parameters of the radar sensor system and structure in order to function properly.

Radar devices may be susceptible to various occurrences that affect the physical parameters of the radar sensor system and structure, such as aging of structural materials, physical damage caused by impact, rain, ice, or snow covering the structural materials.

### SUMMARY

Techniques provided herein are directed toward enabling radar calibration using radar sensors and a radar control system. Embodiments generally include performing measurements by using a plurality of antenna elements to implement analog and/or digital signal transmission and reception, and analyzing measured data with a radar control system in order to determine calibration parameters. Embodiments may further include periodically measuring and/or applying the calibration parameters in the radar control system to compensate for parameters of the radar system and structure that may change over time. Embodiments may further include measuring and/or applying the calibration parameters in the radar control system on the basis of a determined or measured condition.

An example of an apparatus for radar calibration may comprise an external radar antenna assembly, wherein the external radar antenna assembly is operably configured to transmit or receive radar signals while positioned outside of a device housing area, an internal radar antenna assembly, wherein the internal radar antenna assembly is positioned inside of the device housing area, and a radar control system wherein the radar control system is operably configured to either (a) send a first radar signal to the external radar antenna assembly and receive the first radar signal via the internal radar antenna assembly, or (b) send a second radar signal to the internal radar antenna assembly and receive the second radar signal via the external radar antenna assembly, wherein the radar control system is further operably configured to adjust a radar calibration parameter on the basis of the received first radar signal or received second radar signal. In the aforementioned embodiment, the system may also perform (a) then (b), or (b) then (a), or (a) and (b) simultaneously.

An example of a method for radar calibration, may comprise (a) sending, from a radar control system, a first radar signal from an internal radar antenna assembly positioned inside a device housing area to an external radar antenna assembly positioned outside the device housing area and receiving the first radar signal via the internal radar antenna assembly, or (b) sending, from the radar control system, a second radar signal to the internal radar antenna assembly and receiving the second radar signal via the external radar antenna assembly, and then adjusting, with the radar control system, a radar calibration parameter on the basis of the received first radar signal or received second radar signal. In the aforementioned embodiment, the system may also perform (a) then (b), or (b) then (a), or (a) and (b) simultaneously.

An example of a device for radar calibration may comprise for radar calibration may comprise (a) means for sending a first radar signal from an internal radar antenna assembly positioned inside a device housing area to an external radar antenna assembly positioned outside the device housing area and means for receiving the first radar signal via the internal radar antenna assembly, or (b) means for sending a second radar signal to the internal radar antenna assembly and means for receiving the second radar signal via the external radar antenna assembly, and means for adjusting a radar calibration parameter on the basis of the received first radar signal or received second radar signal. In the aforementioned embodiment, the system may also perform (a) then (b), or (b) then (a), or (a) and (b) simultaneously.

An example non-transitory computer-readable medium may comprise instructions that, when executed by a processor, cause (a) a radar control system to send a first radar signal from an internal radar antenna assembly positioned inside a device housing area to an external radar antenna assembly positioned outside the device housing area and to receive the first radar signal via the internal radar antenna assembly, or (b) the radar control system to send a second radar signal to the internal radar antenna assembly and to receive the second radar signal via the external radar antenna assembly, and then the radar control system may adjust a radar calibration parameter on the basis of the received first radar signal or received second radar signal. In the aforementioned embodiment, the system may also perform (a) then (b), or (b) then (a), or (a) and (b) simultaneously.

### BRIEF DESCRIPTION OF THE DRAWINGS

FIG. 1 is a simplified diagram provided to show an implementation of a radar calibration system, according to an embodiment.

FIG. 2 is a simplified diagram provided to show an implementation of an alternative radar calibration system, according to an embodiment.

FIG. 3 is a block diagram of a setup for radar calibration, according to an embodiment.

FIG. 4 is a flow diagram of a method for radar calibration, according to an embodiment.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

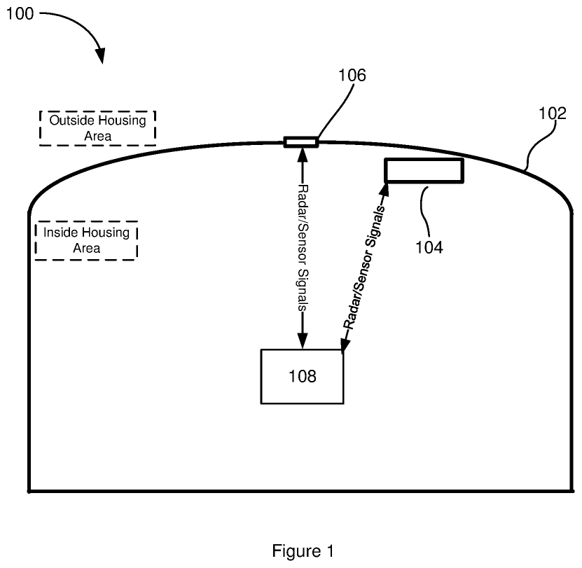

FIG. 1 is a simplified diagram provided to show an implementation of a radar calibration system 100, according to an embodiment. A device housing 102 houses an internal radar antenna assembly 104 and a radar control system 108 inside the device housing 102 area. The internal radar antenna assembly 104 is disposed inside the device housing 102 area such that a radar signal would have to pass through the device housing 102 in order to reach the outside housing area. An external radar antenna assembly 106 is affixed to the device housing 102 area such that its antenna is exposed to the outside housing area. In this configuration or implementation, a radar signal emitted from the external radar antenna assembly 106 would not have to pass through the device housing 102 in order to reach the outside housing area.

The internal radar antenna assembly 104 and external radar antenna assembly 106 comprise radar antennas, which may include cross-polarized dipoles. The radar control system 108 may comprise a processor and/or DSP, memory, transmit (Tx) and receive (Rx) circuitry. The Tx processing circuitry and Rx circuitry may comprise subcomponents for respectively generating and detecting RF signals. The person of ordinary skill in the art will appreciate, the Tx processing circuitry may therefore include a pulse generator, digital-to-analog converter (DAC), a mixer (for up-mixing the signal to the transmit frequency), one or more amplifiers (for powering the transmission via Tx antenna), etc. The Rx processing circuitry may have similar hardware for processing a detected RF signal. In particular, the Rx processing circuitry may comprise an amplifier (for amplifying a signal received via Rx antenna), a mixer for down converting the received signal from the transmit frequency, and analog-to-digital converter (ADC) for digitizing the received signal, and a pulse correlator providing a matched filter for the pulse generated by the Tx processing circuitry

It can be noted that the properties of the transmitted RF signal may vary, depending on the technologies utilized. Techniques provided herein can apply generally to “mmWave” technologies, which range from 30 GHz to 300 GHz. This includes, for example, frequencies utilized by the 802.11ad Wi-Fi standard (operating at 60 GHz). Moreover, techniques may apply to RF signals comprising any of a variety of pulse types, including compressed pulses (e.g., comprising Chirp, Golay, Barker, or Ipatov sequences, etc.) may be utilized. That said, embodiments are not limited to such frequencies and/or pulse types.

The radar control system 108 may be operably configured to send a first radar signal to the external radar antenna assembly 106 and receive the transmitted signal, after the transmitted signal passes through the device housing 102 and potentially reflects off an external object, via the internal radar antenna assembly 104. Alternatively, the radar control system 108 may be operably configured to send a second radar signal to the internal radar antenna assembly 104 and receive the transmitted signal, after the transmitted signal passes through the device housing 102 and potentially reflects off an external object, via the external radar antenna assembly 106.

The radar control system 108 is further configured to adjust a radar calibration parameter on the basis of the received first radar signal or received second radar signal. The calibration parameter may be adjusted based upon a comparison of the received first radar signal or second radar signal with the transmitted first radar signal or the transmitted second radar signal, respectively, or by various measurements of the received first radar signal or the received second radar signal. Signal processing techniques may be employed simultaneously with the receipt and transmission of the radar signal. For example, the radar calibration parameter may be determined concurrently with the transmission and receipt of the radar signal.

In an alternative implementation, the internal radar antenna assembly 104 and the external radar antenna assembly 106 spaced more than 3 cm and less than 10 cm apart from one another.

In an alternative implementation, the radar calibration system 100 may further have a radar control system 108 process a received first radar signal or received second radar signal to determine a radar signal attenuation or transmit or receive phase retardation.

In an alternative implementation, the internal radar antenna assembly 104 and the external radar antenna assembly 106 spaced more than 10 wavelengths of the first or second radar signal apart from one another.

In an alternative implementation, the internal radar antenna assembly 104 and the external radar antenna assembly 106 may comprise two cross-polarized dipoles.

In an alternative implementation, the internal radar antenna assembly 104 and the external radar antenna assembly 106 may comprise a radome.

In an alternative implementation, the internal radar antenna assembly 104 and the external radar antenna assembly 106 may be proximate to thermoelectric elements. Such thermoelectric elements provide the benefit of heating or cooling the radar assembly to a desired temperature.

In an alternative implementation, the radar calibration system 100 may further have a radar control system 108 configured to determine a calibration parameter of a transmit path. In an alternative implementation, the radar calibration system 100 may further have a radar control system 108 determine a calibration parameter of a receive path.

In an alternative implementation, the radar calibration system 100 may further have a radar control system 108 configured to compare the received first radar signal to the sent first radar signal, or to compare the received second radar signal to the sent second radar signal.

In an alternative implementation, the radar calibration system 100 may be integrated into an automobile, such as into or behind a bumper or body panel.

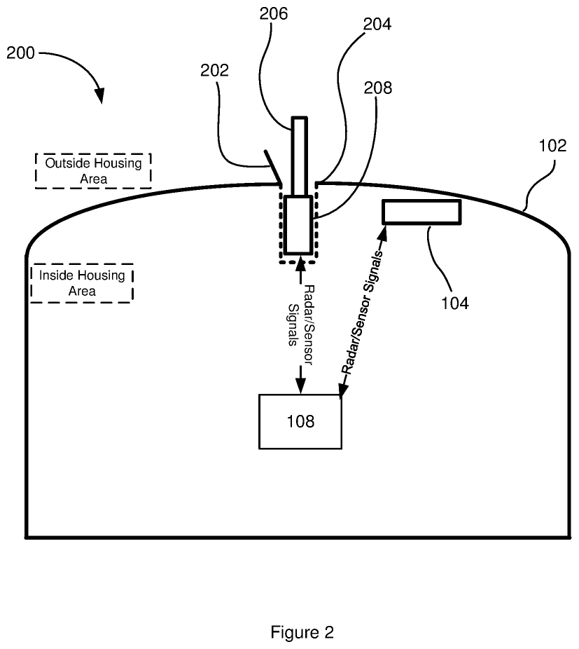

FIG. 2 is a simplified diagram provided to show an implementation of an alternative radar calibration system 200, according to an embodiment. A device housing 102 houses an internal radar antenna assembly 104, a retractable external radar antenna assembly 206, and a radar control system 108 inside the device housing 102 area. The internal radar antenna assembly 104 is disposed inside the device housing 102 area such that a radar signal would have to pass through the device housing 102 in order to reach the outside housing area and the retractable external radar antenna assembly 206. The retractable external radar antenna assembly 206 may be mounted inside the device housing 102 area such that its antenna may be deployed, via a deployment/retraction mechanism 208, to the outside housing area such that a radar signal emitted from the retractable external radar antenna assembly 206 would not have to pass through the device housing 102 in order to reach the outside housing area. The deployment/retraction mechanism 208 and retractable external radar antenna assembly 206 may be mounted behind a hinged mechanism 202 which closes to seal opening 204. The radar control system 108 may send a signal to deploy the retractable external radar antenna assembly 206 from a position inside the device housing 102 area to a position outside the device housing 102 area and to retract the retractable external radar antenna assembly from a position outside the device housing 102 area to a position inside the device housing 102 area. The deployment/retraction mechanism 208 may use a motor, springs, piezoelectric actuator, or other means of deploying and retracting the retractable external radar antenna assembly 206.

In an alternative implementation, the radar calibration system 200 may further have a radar control system 108 receive a signal indicating a condition and deploy the retractable external radar antenna assembly 206 from a position inside the device housing 102 area to a position outside the device housing 102 area based upon the indicated condition. Such a condition may be one or more of the following a deformation of the device housing area material, an accumulation of dirt, dust, ice, or snow on the device housing area, a humidity or moisture level, an impact, shock, or acceleration, a time measurement, or a temperature measurement. Other conditions provided by other environmental sensors may also be used.

In an alternative implementation, the radar calibration system 200 may further have a radar control system 108 process a received first radar signal or received second radar signal to determine a radar signal attenuation or transmit or receive phase retardation.

In an alternative embodiment, the internal radar antenna assembly 104 and the retractable external radar antenna assembly 206 spaced more than 10 wavelengths of the radar signal apart from one another.

In an alternative embodiment, the internal radar antenna assembly 104 and the retractable external radar antenna assembly 206 may comprise two cross-polarized dipoles.

In an alternative embodiment, the internal radar antenna assembly 104 and the retractable external radar antenna assembly 206 may comprise a radome.

In an alternative embodiment, the internal radar antenna assembly 104 and the retractable external radar antenna assembly 206 may be proximate to thermoelectric elements. Such thermoelectric elements provide the benefit of heating or cooling the radar assembly to a desired temperature.

In an alternative embodiment, the radar calibration system 200 may further have a radar control system 108 configured to determine a calibration parameter of a transmit path. In an alternative embodiment, the radar calibration system 200 may further have a radar control system 108 determine a calibration parameter of a receive path.

In an alternative embodiment, the radar calibration system 200 may further have a radar control system 108 configured to compare the received first radar signal to the sent first radar signal, or to compare the received second radar signal to the sent second radar signal.

In an alternative embodiment, the radar calibration system 200 may be integrated into an automobile, such as into or behind a bumper or body panel.

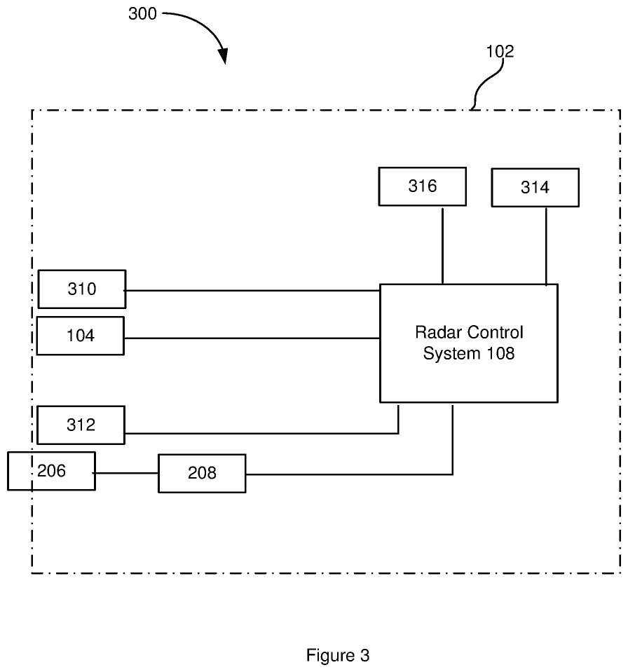

FIG. 3 is a block diagram of a setup for radar calibration 300, according to an embodiment. An internal radar antenna assembly 104 disposed inside of a device housing 102 area, a retractable external radar antenna assembly 206, and a radar control system 108. The internal radar antenna assembly 104 is disposed inside the device housing 102 area such that a radar signal would have to pass through the device housing 102 in order to reach the outside housing area and the retractable external radar antenna assembly 206. The retractable external radar antenna assembly 206 may be mounted inside the device housing 102 area such that its antenna may be deployed, via a deployment/retraction mechanism 208, to the outside housing area such that a radar signal emitted from the retractable external radar antenna assembly 206 would not have to pass through the device housing 102 in order to reach the outside housing area.

A first sensor 310 and a second sensor 312 may be used to sense conditions proximate to an internal radar antenna assembly 104 and a retractable external radar antenna assembly 206, respectively. Such sensors may be used to sense indicators proximate to the internal radar antenna assembly 104 and the retractable external radar antenna assembly 206. These sensed indicators may be received by the radar control system 108 in order to determine conditions at the internal radar antenna assembly 104 and the retractable external radar antenna assembly 206. The radar control system 108 may be operably connected to a memory 314 and a communication interface 316.

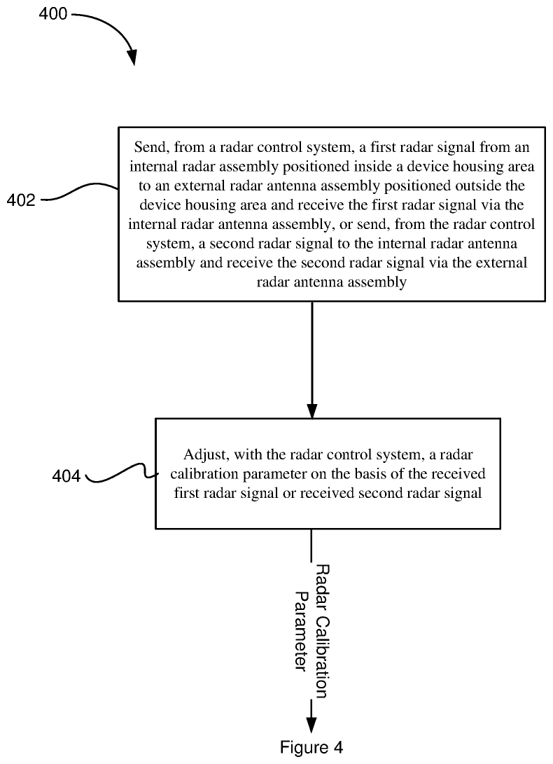

FIG. 4 is a flow diagram of a method for radar calibration 400, according to an embodiment. At step 402, the method comprises a) sending, from a radar control system, a first radar signal from an internal radar antenna assembly positioned inside a device housing area to an external radar antenna assembly positioned outside the device housing area and receiving the first radar signal via the internal radar antenna assembly, or b) sending, from the radar control system, a second radar signal to the internal radar antenna assembly and receiving the second radar signal via the external radar antenna assembly. At step 404, the method comprises adjusting, with the radar control system, a radar calibration parameter on the basis of the received first radar signal or received second radar signal. Step 404 produces a radar calibration parameter that may be used to adjust characteristics of the radar transmission or reception of the internal radar antenna assembly 104, external radar antenna assembly 106, or retractable external radar antenna assembly 206.

The radar calibration parameter may be used to calibrate radar signals sent to radar assemblies or received from radar assemblies. After calibration, the system may periodically recalibrate by repeating the method of radar calibration 400. This may be done on the basis of a timer or a request from a user. This may also be done based upon certain events, such as every time an automobile is started up or shut down.

In an alternative embodiment, the method for radar calibration may further comprise steps not shown, such as sending, from the radar control system, a signal to deploy the external radar antenna assembly from a position inside a device housing area to a position outside the device housing area; and sending, from the radar control system, a signal to retract the external radar antenna assembly from a position outside the device housing area to a position inside the device housing area.

In an alternative embodiment, the method for radar calibration may further comprise receiving a signal, at the radar control system, indicating a condition; sending a signal, from the radar control system, to deploy the external radar antenna assembly from a position inside the device housing area to a position outside the device housing area based upon the indicated condition. sending, from the radar control system, a signal to retract the external radar antenna assembly from a position outside the device housing area to a position inside the device housing area. Such a condition may be one or more of the following a deformation of the device housing area material, an accumulation of dirt, dust, ice, or snow on the device housing area, a humidity or moisture level, an impact, shock, or acceleration, a time measurement, or a temperature measurement. Other conditions provided by other environmental sensors may also be used.

In an alternative embodiment, the method for radar calibration may further comprise processing the received first radar signal or received second radar signal to determine at least one of a radar signal attenuation, or a transmit or receive phase retardation.

In an alternative embodiment, the method for radar calibration may further comprise sending a control signal, via the radar control system, to a thermoelectric element, wherein the control signal causes the thermoelectric element to increase or decrease temperature. One advantage of using a thermoelectric element would be the ability to compensate for environmental temperature swings, or temperature swings caused by engine heat in an automobile.

It can be noted that, although particular frequencies, integrated circuits (ICs), hardware, and other features are described in the embodiments herein, alternative embodiments may vary. That is, alternative embodiments may utilize additional or alternative frequencies (e.g., other the 60 GHz and/or 28 GHz frequency bands, or even outside mmWave frequencies (30 GHz to 300 GHz), antenna elements (e.g., having different size/shape of antenna element arrays), scanning periods (including both static and dynamic scanning periods), electronic devices (e.g., mobile phones, tablets, personal computer (PC), etc.), and/or other features. A person of ordinary skill in the art will appreciate such variations.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, any other physical medium with patterns of holes, a RAM, a Programmable ROM (PROM), Erasable PROM (EPROM), a flash-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it is noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

What is claimed is:

1. An apparatus for radar calibration, comprising:
an external radar antenna assembly, wherein the external radar antenna assembly is operably configured to transmit or receive radar signals while positioned outside of a device housing area;
an internal radar antenna assembly, wherein the internal radar antenna assembly is positioned inside of the device housing area; and
a radar control system;
wherein the radar control system is operably configured to:
a) send a first radar signal to the external radar antenna assembly and receive the first radar signal via the internal radar antenna assembly, or
b) send a second radar signal to the internal radar antenna assembly and receive the second radar signal via the external radar antenna assembly;
wherein the radar control system is further operably configured to adjust a radar calibration parameter on the basis of the received first radar signal or the received second radar signal.

2. The apparatus of claim 1, wherein the radar control system is further configured to:
deploy the external radar antenna assembly from a position inside the device housing area to a position outside the device housing area; and
retract the external radar antenna assembly from a position outside the device housing area to a position inside the device housing area.

3. The apparatus of claim 2, wherein the radar control system is further configured to:
receive a signal indicating a condition;
deploy the external radar antenna assembly from the position inside the device housing area to the position outside the device housing area based upon the indicated condition.

4. The apparatus of claim 3, wherein the condition is at least one of:
a) a deformation of the device housing area material,
b) an accumulation of dirt, dust, ice, or snow on the device housing area,
c) a humidity or moisture level,
d) an impact, shock, or acceleration,
e) a time measurement, or
f) a temperature measurement.

5. The apparatus of claim 1, wherein the radar control system is further configured to:
process the received first radar signal or the received second radar signal to determine at least one element of:
a) radar signal attenuation, or
b) transmit or receive phase retardation.

6. The apparatus of claim 1, wherein the internal radar antenna assembly and external radar antenna assembly are spaced more than 3 cm and less than 10 cm apart.

7. The apparatus of claim 1, wherein the internal radar antenna assembly and external radar antenna assembly are spaced more than 10 wavelengths of the first radar signal apart.

8. The apparatus of claim 1, wherein the internal radar antenna assembly and external radar antenna assembly include two cross-polarized dipoles.

9. The apparatus of claim 1, wherein the internal radar antenna assembly and external radar antenna assembly comprise a radome.

10. The apparatus of claim 1, wherein the internal radar antenna assembly and external radar antenna assembly comprise thermoelectric elements.

11. The apparatus of claim 1, wherein the radar calibration parameter comprises a calibration parameter of a transmit path.

12. The apparatus of claim 1, wherein the radar calibration parameter comprises a calibration parameter of a receive path.

13. The apparatus of claim 1, wherein the radar control system is configured to compare the received first radar signal to the sent first radar signal, or to compare the received second radar signal to the sent second radar signal.

14. The apparatus of claim 1, wherein the device housing area is a body of an automobile.

15. A method for radar calibration, comprising:
a) sending, from a radar control system, a first radar signal from an internal radar antenna assembly positioned inside a device housing area to an external radar antenna assembly positioned outside the device housing area and receiving the first radar signal via the internal radar antenna assembly, or
b) sending, from the radar control system, a second radar signal to the internal radar antenna assembly and receiving the second radar signal via the external radar antenna assembly; and
adjusting, with the radar control system, a radar calibration parameter on the basis of the received first radar signal or the received second radar signal.

16. The method of claim 15, further comprising:
sending, from the radar control system, a signal to deploy the external radar antenna assembly from a position inside the device housing area to a position outside the device housing area; and
sending, from the radar control system, a signal to retract the external radar antenna assembly from a position outside the device housing area to a position inside the device housing area.

17. The method of claim 16, further comprising:
receiving a signal, at the radar control system, indicating a condition;
sending a signal, from the radar control system, to deploy the external radar antenna assembly from the position inside the device housing area to the position outside the device housing area based upon the indicated condition.

18. The method of claim 17, wherein the condition is at least one of:
a) a deformation of device housing area material,
b) an accumulation of dirt, dust, ice, or snow on the device housing area,
c) a humidity or moisture level,
d) an impact, shock, or acceleration,
e) a time measurement, or
f) a temperature measurement.

19. The method of claim 15, further comprising:
processing the received first radar signal or the received second radar signal to determine at least one of:
a) radar signal attenuation, or
b) transmit or receive phase retardation.

20. The method of claim 15, further comprising:
sending a control signal, via the radar control system, to a thermoelectric element, wherein the control signal causes the thermoelectric element to increase or decrease temperature.

21. A system for radar calibration, comprising:
a) means for sending a first radar signal from an internal radar antenna assembly positioned inside a device housing area to an external radar antenna assembly positioned outside the device housing area and means for receiving the first radar signal via the internal radar antenna assembly, or
b) means for sending a second radar signal to the internal radar antenna assembly and means for receiving the second radar signal via the external radar antenna assembly; and
means for adjusting a radar calibration parameter on the basis of the received first radar signal or the received second radar signal.

22. The system for radar calibration of claim 21, further comprising:
means for sending a signal to deploy the external radar antenna assembly from a position inside the device housing area to a position outside the device housing area; and
means for sending a signal to retract the external radar antenna assembly from a position outside the device housing area to a position inside the device housing area.

23. The system for radar calibration of claim 22, further comprising:
means for receiving a signal indicating a condition;
means for sending a signal to deploy the external radar antenna assembly from the position inside the device housing area to the position outside the device housing area based upon the indicated condition.

24. The system for radar calibration of claim 23, wherein the condition is at least one of:
a) a deformation of device housing area material,
b) an accumulation of dirt, dust, ice, or snow on the device housing area,
c) a humidity or moisture level,
d) an impact, shock, or acceleration,
e) a time measurement, or
f) a temperature measurement.

25. The system for radar calibration of claim 21, further comprising:
means for processing the received first radar signal or the received second radar signal to determine at least one of:
a) radar signal attenuation, or
b) transmit or receive phase retardation.

26. The system for radar calibration of claim 21, further comprising:
means for sending a control signal to a thermoelectric element, wherein the control signal causes the thermoelectric element to increase or decrease temperature.

27. A non-transitory computer-readable medium comprising instructions that, when executed by a processor, cause:
a) a radar control system to send a first radar signal from an internal radar antenna assembly positioned inside a device housing area to an external radar antenna assembly positioned outside the device housing area and to receive the first radar signal via the internal radar antenna assembly, or
b) the radar control system to send a second radar signal to the internal radar antenna assembly and to receive the second radar signal via the external radar antenna assembly; and
the radar control system to adjust a radar calibration parameter on the basis of the received first radar signal or the received second radar signal.

28. The non-transitory computer-readable medium of claim 27, further comprising instructions that, when executed by the processor, cause:
the radar control system to send a signal to deploy the external radar antenna assembly from a position inside the device housing area to a position outside the device housing area; and
the radar control system to send a signal to retract the external radar antenna assembly from a position outside the device housing area to a position inside the device housing area.

29. The non-transitory computer-readable medium of claim 28, further comprising instructions that, when executed by the processor, cause:
the radar control system to process the received first radar signal or the received second radar signal to determine at least one of:
a) radar signal attenuation or
b) transmit or receive phase retardation.

30. The non-transitory computer-readable medium of claim 29, further comprising instructions that, when executed by the processor, cause the radar control system to compare the received first radar signal to the sent first radar signal, or to compare the received second radar signal to the sent second radar signal.
